(19) United States
(12) Patent Application Publication
(10) Pub. No.: US 2024/0332753 A1
(43) Pub. Date: Oct. 3, 2024

(54) ELECTROCHEMICAL ASSEMBLY, CORRESPONDING ELECTROCHEMICAL CELL, BATTERY AND METHOD OF MANUFACTURING

(71) Applicant: SAFT, LEVALLOIS PERRET (FR)

(72) Inventors: Kyle ALCIDE, Saint Johns, FL (US); Andrew ANDERSON, Jacksonville, FL (US); Sébastien BADET, LE TAILLAN MEDOC (FR); Gilles PHILIPPE, IZON (FR)

(73) Assignee: SAFT, LEVALLOIS PERRET (FR)

(21) Appl. No.: 18/681,545

(22) PCT Filed: Aug. 18, 2021
(86) PCT No.: PCT/IB2021/000732

§ 371 Date: Feb. 6, 2024

(51) Int. Cl. H01M 50/538; H01M 10/0583; H01M 50/103; H01M 50/15; H01M 50/209; H01M 50/536

(52) U.S. Cl. CPC H01M 50/538; H01M 10/0583; H01M 50/103; H01M 50/15; H01M 50/209; H01M 50/536

(57) ABSTRACT

This electrochemical assembly comprises a first electrochemical stack, having first stack electrodes of a first polarity and first stack electrodes of a second polarity. The first stack electrodes of the first polarity comprise first terminal tabs of the first polarity and forming a first electric terminal tab stack.

The electrochemical assembly comprises a second electrochemical stack, having second stack electrodes of the first polarity and second stack electrodes of the second polarity. The second stack electrodes of the first polarity comprise second terminal tabs of the first polarity and forming a second electric terminal tab stack.

The electrochemical assembly comprises a first terminal comprising a terminal portion and a tab connection portion. The first electric terminal tab stack overlaps the second electric terminal tab stack and is electrically connected to the tab connection portion of the first terminal via the second electric terminal tab stack.

### CROSS REFERENCE TO RELATED APPLICATION

The present application is a U.S. National Phase Application under 35 U.S.C. § 371 of International Patent Application No. PCT/IB2021/000732 filed Aug. 18, 2021. The entire contents of which are hereby incorporated by reference.

### FIELD OF THE INVENTION

The present invention concerns an electrochemical assembly, comprising
a first electrochemical stack, the first electrochemical stack comprising first stack electrodes of a first polarity and first stack electrodes of a second polarity, the first stack electrodes of the first polarity comprising a plurality of first terminal tabs of the first polarity, the first terminal tabs of the first polarity forming a first electric terminal tab stack,
a second electrochemical stack, the second electrochemical stack comprising second stack electrodes of the first polarity and second stack electrodes of the second polarity, the second stack electrodes of the first polarity comprising a plurality of second terminal tabs of the first polarity, the second terminal tabs of the first polarity forming a second electric terminal tab stack,
a first terminal comprising a terminal portion and a tab connection portion.

### BACKGROUND

An electrochemical cell or electrochemical generator is a device for generating electricity in which chemical energy is converted into electrical energy. The chemical energy consists of electrochemically active compounds deposited on at least one side of electrodes arranged in the electrochemical generator. The electrical energy is produced by electrochemical reactions during a discharge of the electrochemical generator. The electrodes, arranged in a container, are electrically connected to current output terminals that provide electrical continuity between the electrodes and an electrical consumer with which the electrochemical generator is associated.

Several electrochemical generators can be connected together in series or in parallel depending on the nominal operating voltage of the electrical consumer and the amount of energy intended to be supplied to that consumer. The electrochemical generators are then placed in a common container and the container and the plurality of electrochemical generators contained therein are generally referred to as a secondary battery. For convenience of electrical connection between electrochemical generators placed in a secondary battery, the positive and negative current output terminals are often attached to the wall of the same side of the container, often to a cover intended to close the container.

A secondary battery is known from U.S. Pat. No. 9,728,787B2. This document discloses a secondary battery comprising a case and a lid. Terminal portions project through the lid. An electrode group is arranged inside the case. A current collecting structure is arranged between the electrode group and each of the terminal portions. The electrode group comprises several stacks of current collector tabs. Each stack of tabs is welded to a welded portion of one angled current collecting plate. Each of the angled current collecting plates has a different angle. The current collecting plates comprise each a fixed portion that are superposed and clamped one to another and to a terminal body portion.

This secondary battery has a rather complicated structure and a high volume for a given electrical capacity.

Other secondary batteries are known from U.S. Pat. No. 10,141,560B2, JP2014238941A, EP1898481A1, and WO2019166641A1.

### SUMMARY

It is an objective of the invention to improve the secondary batteries of the prior art and provide an electrochemical assembly that it easy and economical to manufacture and that is reliable while being small for a given battery capacity.

In order to achieve at least one of the above objects, the invention relates to an electrochemical assembly as defined by claim 1.

According to specific embodiments, the electrochemical assembly according to the invention may comprise one or more of the following features, taken alone or together in all technically possible combinations:
each of the first stack electrodes of the first polarity comprises a first current collector and an electrochemical active material, each first terminal tab of the first polarity being one-piece or integral with one of the first current collectors, wherein
the first electrochemical stack defines a first stack median plane, and
each of the second stack electrodes of the first polarity comprises a second current collector and an electrochemical active material, each second terminal tab of the first polarity being one-piece or integral with one of the second current collectors, wherein
the second electrochemical stack defines a second stack median plane;
the first electric terminal tab stack is offset with respect to the first stack median plane,
the second electric terminal tab stack is offset with respect to the second stack median plane,
in particular wherein the first electric terminal tab stack extends along a first tab stack plane and the second electric terminal tab stack extends along a second tab stack plane, and/or
in particular wherein the first electric terminal tab stack and second electric terminal tab stack, and/or the first tab stack plane and the second tab stack plane, are offset from the respective stack median plane at a side either remote from or close to the second electrochemical stack respectively either remote from or close to the first electrochemical stack;
the first electric terminal tab stack is essentially aligned with the first stack median plane and the second electric terminal tab stack is essentially aligned with respect to the second stack median plane;
the first electrochemical stack defines a first stack outer face, and a first stack inner face, and
each first terminal tab of the first polarity comprises a first free terminal tab portion extending between the associated first current collector and the first electric terminal tab stack, each first free terminal tab portion defining a first effective length, and,
from each group of two adjacent first terminal tabs, the first terminal tab being closer to the first tab stack plane has a shorter first effective length of the first free terminal tab portion than the first terminal tab being more distant from the first tab stack plane;
the second electrochemical stack defines a second stack outer face and a second stack inner face,
each second terminal tab of the first polarity comprises a second free terminal tab portion extending between the associated second current collector and the second electric terminal tab stack, each free terminal tab portion defining a second effective length, and
from each group of two adjacent second terminal tabs, the second terminal tab being closer to the second tab stack plane has a shorter second effective length of the second free terminal tab portion than the second terminal tab being more distant from the second tab stack plane;
all the first terminal tabs and all the second terminal tabs are entirely arranged within a space extending between two boundary planes coinciding with the first stack outer face respectively with the second stack outer face;
the electrochemical assembly comprises a common tab connecting element,
the common tab connecting element is interposed between the second electric terminal tab stack of the first polarity and the tab connection portion of the first terminal and,
the common tab connecting element electrically connects the second terminal tab stack of the first polarity to the tab connection portion of the first terminal and electrically links the first terminal tab stack and the second terminal tab stack to the terminal portion of the first terminal;
the electrochemical assembly comprises no common tab connecting element and the second terminal tab stack is directly connected to the tab connection portion of the first terminal.

A further object of the invention is an electrochemical cell, comprising a casing, a casing cover and an electrochemical assembly, characterized in that the electrochemical assembly is an electrochemical assembly as defined here above, and in that the first electrochemical stack and the second electrochemical stack are arranged inside the casing.

A further object of the invention is a battery, comprising a plurality of electrochemical cells as defined here above.

The invention relates also to a method of manufacturing an electrochemical assembly as defined hereabove, comprising the steps of:
A) providing
   the first electrochemical stack,
   the second electrochemical stack,
   the first terminal, the first terminal being of a first polarity,
the first electrochemical stack defining a first stack median plane, and
the second electrochemical stack defining a second stack median plane,
B) arranging the first electrochemical stack and the second electrochemical stack so that the first and second stack median planes are substantially coplanar and the first electric terminal tab stack overlaps the second electric terminal tab stack,
C) welding the first electric terminal tab stack to the second electric terminal tab stack, and
D) folding the first electrochemical stack and the second electrochemical stack so that the first and second stack median planes are substantially parallel and spaced one from another.

According to specific embodiments, the method according to the invention may comprise the following features, taken alone or together in all technically possible combinations:

either for manufacturing an electrochemical assembly as above, wherein during step C) the second electric terminal tab stack is simultaneously welded to the common tab connecting element or
for manufacturing an electrochemical assembly as above, wherein during step C) the second electric terminal tab stack is simultaneously welded directly to the tab connection portion.

It is contemplated that the various features set forth in the preceding paragraphs, in the claims and/or in the following description and drawings may be taken independently or in any combination thereof. For example, features disclosed in connection with one embodiment are applicable to all embodiments, except where there is technical incompatibility of features.

Furthermore, the statements contained in the description relate to particular embodiments and are not to be construed as limitations on the scope of the invention or on the definition of terms used in the claims, except where a term or phrase is expressly defined. Various other embodiments and various changes and modifications to the disclosed embodiment(s) will become apparent to those skilled in the art. All such other embodiments, changes, and modifications are intended to come within the scope of the appended claims.

Also, where a group of features is disclosed, this disclosed group should also be considered as disclosing any sub-group that is technically possible.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

Also, each functional feature of a disclosed object, as disclosed for example by “adapted to” or “for”, should be understood as disclosing the corresponding method step during use of the object.

The expressions “isolation”, “conductivity”, and the like, which exist as mechanical, thermal or electrical features, are to be interpreted as electrical features only in the present specification, unless specified otherwise.

### BRIEF DESCRIPTION OF THE DRAWINGS

The invention will be better understood in light of the following specification, which refers to the annexed figures, which show:

FIG. 1 an exploded perspective view of a battery according to the present invention;

FIG. 2 a schematic cross section of an electrochemical cell comprising an electrochemical assembly according to the present invention;

FIG. 3 an image of a cross cut of an electrochemical battery according to the invention, corresponding to the view of FIG. 2;

FIG. 4 is a schematic view of the electrochemical assembly according to the invention during a manufacturing step of the electrochemical cell of FIG. 2;

FIG. 5 is an enlarged view of detail V of FIG. 4;

FIG. 6 is a schematic view of the electrochemical assembly according to the invention during a further manufacturing step of the electrochemical cell of FIG. 2;

FIG. 7 is a view corresponding to that of FIG. 2 of a variant of the electrochemical cell of FIGS. 1 to 6; and

FIG. 8 is a view corresponding to the view of FIG. 5 of another variant of an electrochemical cell of FIGS. 1 to 6.

### DETAILED DESCRIPTION

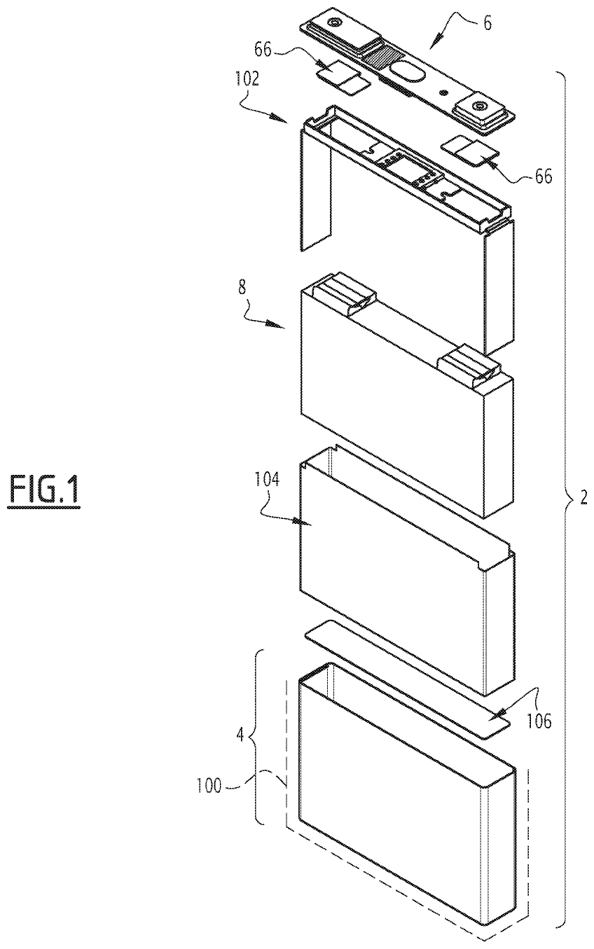

FIG. 1 is an exploded perspective view of a battery 100 according to the present invention.

The battery 100 comprises several electrochemical cells 2 (of which only one is depicted) arranged in a battery container.

The electrochemical cell 2 comprises a casing 4, a casing cover 6 and an electrochemical assembly 8. The electrochemical cell 2 comprises also top and lateral shim 102, an adhesive sleeve 104, made for example from polyimide, and a bottom shim 106, made for example from polypropylene.

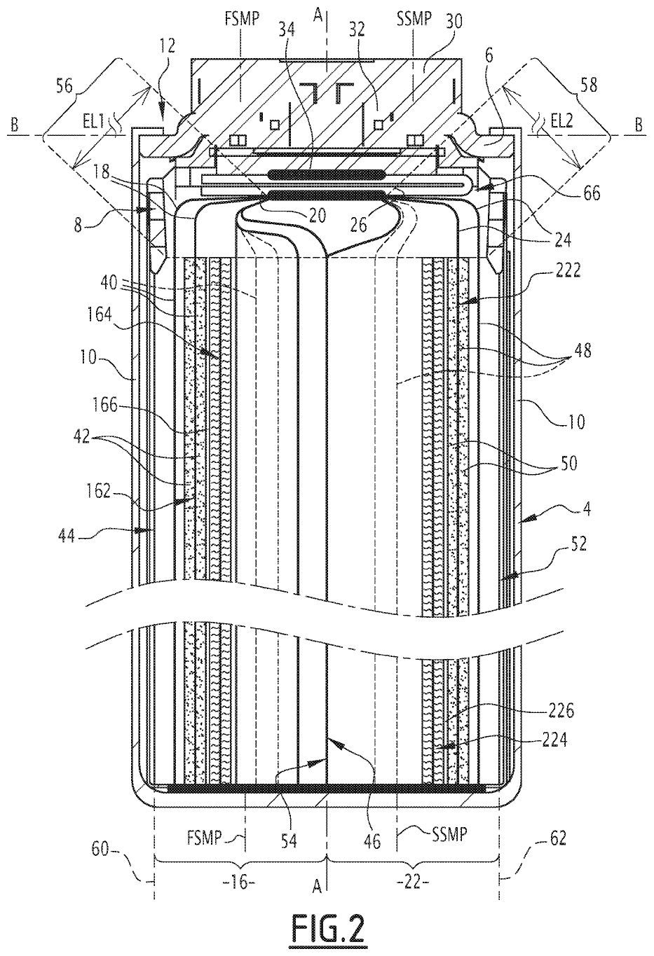

FIG. 2 shows schematically the electrochemical cell 2 according to the invention in a cross-section. The electrochemical cell 2 is presently a secondary cell, notably a Lithium-Ion electrochemical cell.

The casing 4 has at least two parallel casing walls 10. The casing 4 is for example a prismatic, box-shaped, rectangular parallelepiped casing. As a variant, the casing has rounded small sides connecting the casing walls 10. The casing walls 10 are the largest walls of the casing. The casing 4 defines a casing opening 12 on one side of the casing walls 10.

The casing 4 defines a median plane A-A extending parallel to the casing walls 10 and at equal distance from theses casing walls. The median plane A-A extends perpendicular to the plane of projection of FIG. 2.

The casing 4 is for example made from metal or from thermoplastics. The casing walls are less deformable than the first stack outer face 44 and second stack outer face 52 of the electrochemical assembly 8 (see below).

The casing cover 6 is arranged on the casing 4 and closes the casing opening 12. The casing cover 6 is substantially planar and extends along a casing cover plane B-B, which is perpendicular to the median plane A-A and in FIG. 2, perpendicular to the plane of projection.

The electrochemical assembly 8 comprises a first electrochemical stack 16, comprising first stack electrodes of a first polarity 162 and first stack electrodes of a second polarity 164. Furthermore, the first electrochemical stack 16 includes separators 166.

The first electrochemical stack 16 comprises a plurality of first terminal tabs 18 of the first polarity, the first terminal tabs of the first polarity forming a first electric terminal tab stack 20 of the first polarity.

The electrochemical assembly 8 comprises a second electrochemical stack 22 comprising second stack electrodes of the first polarity 222 and second stack electrodes of the second polarity 224. The second electrochemical stack 22 includes furthermore separators 226.

The second electrochemical stack 22 comprises a plurality of second terminal tabs 24 forming a second electric terminal tab stack 26. The second electric terminal tab stack 26 is of the same polarity as the polarity of the first electric terminal tab stack 20.

The electrochemical assembly 8 further comprises a first terminal 30 of the first polarity comprising a terminal portion 32 and a tab connection portion 34. The terminal portion 32 comprises a face for electrically connecting the electrochemical assembly to a neighboring electrochemical assembly. The tab connecting portion 34 comprises a face to which the first or second terminal tab stack is bonded (see below).

The first electrochemical stack 16 and the second electrochemical stack 22 of electrochemical elements are arranged inside the casing 4.

The first electrochemical stack 16 is generated by alternately stacking a plurality of positive electrodes (e.g. the first stack electrodes of the first polarity 162) and a plurality of negative electrodes (e.g. the first stack electrodes of the second polarity 164) via separators (e.g. separators 166). The separators prevent the positive electrodes and the negative electrodes from contacting each other to cause a short circuit.

The positive electrode includes a positive current collector formed from for example an aluminum foil formed in a generally substantially rectangular plate shape, and a positive active material layer provided on only one or on both surfaces of the positive current collector. The positive active material layer comprises for example a lithiated oxide of nickel, manganese and cobalt (“NMC” type), graphite, and polyvinylidene fluoride (PVDF) as well as a dispersion solvent (e.g. NMP). A positive tab is integrally formed on a side of the positive current collector, for example the side extending along the casing cover 6, and may be a non-coated portion. The positive tabs are aligned one over the other and form a tab stack.

The negative electrode includes a negative current collector formed from for example an electrolytic copper foil formed in a substantially rectangular plate shape, and negative active material layers provided on only one or on both surfaces of the negative current collector. The negative active material layers may comprise one or more binding agents (e.g. carboxymethylcellulose (CMC) and styrene-butadiene copolymer (SBR)) and graphite as a negative active material, as well as a dispersion solvent (e.g. NMP).

The negative current collector may have a thickness in the range from 6 μm to 20 μm. A negative tab is integrally formed on a side of the negative current collector, for example the side extending along the casing cover. The negative tabs are aligned one over the other and form a tab stack. The negative tabs are formed not to face the positive tabs when the positive electrodes and the negative electrodes are stacked.

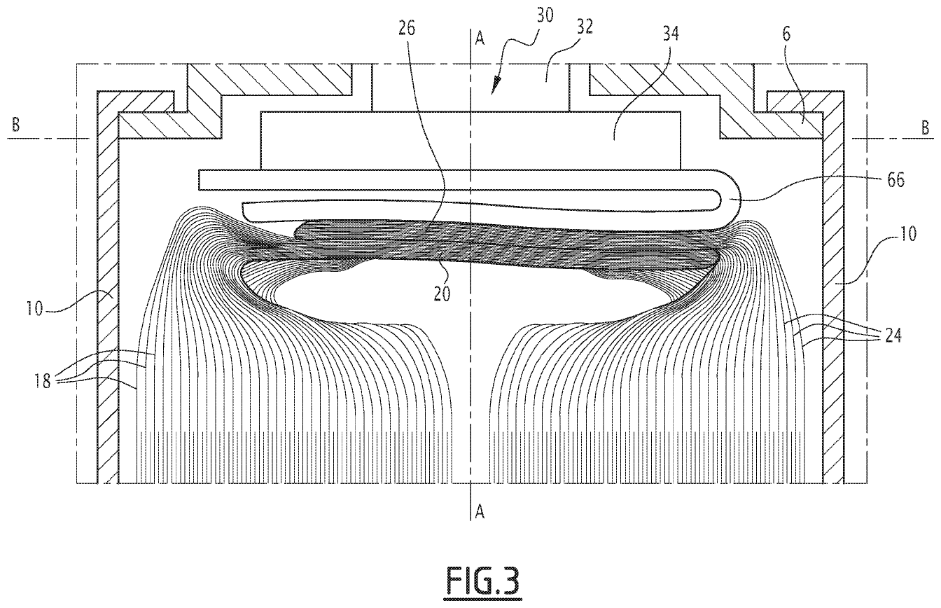

The separators are formed generally in a substantially rectangular sheet shape from a porous material made of polyolefin (e.g. polyethylene or polypropylene) that enables passage of lithium ions. The separators are sized to hinder contact between the positive current collectors of the positive electrodes and the negative current collectors of the negative electrodes in a stacked state. In FIG. 2, in order to facilitate illustration, only few positive electrodes, few negative electrodes, and few separators are illustrated. In the electrochemical cell 2 according to a real embodiment (see FIG. 3), however a large number of positive electrodes, negative electrodes, and twice the number of separators are stacked to constitute the first electrochemical stack 16 respectively the second electrochemical stack 22.

In the framework of the present invention, in the following it will be referred to the first current collectors, which are either the positive current collectors of the first electrochemical stack or the negative current collectors of the first electrochemical stack. Likewise, it will be referred to the second current collectors, which are either the positive current collectors of the second electrochemical stack of electrochemical elements or the negative current collectors of the second electrochemical stack of electrochemical elements, but are those of the same polarity as the considered first current collectors. It is to be understood that the structure of the electrochemical assembly is similar for the current collectors of the other polarity.

Thus, each of the first stack electrodes 162 of the first polarity comprises a first current collector 40 of the first polarity and layers comprising electrochemical active material 42, each first terminal tab 18 of the first polarity being one-piece or integral with one of the first current collectors. The layer(s) of electrochemical active material 42 may be arranged on only one single side or on both sides of each first current collector 40. The electrochemical active material 42 may be a mixture comprising other materials.

Each first terminal tab 18 of the first polarity may be a non-coated portion of the first current collector 40.

The first electrochemical stack 16 defines a first stack median plane FSMP.

The first electrochemical stack 16 defines a first stack outer face 44 and a first stack inner face 46, the first stack inner face 46 being closer to the second electrochemical stack 22 than the first stack outer face 44. The first stack outer face 44 and the first stack inner face 46 are parallel to one another and the first stack median plane FSMP extends parallel to the first stack outer face 44 and the first stack inner face 46 at half the distance of these two faces.

Each of the second stack electrodes 222 of the first polarity comprises a second current collector 48 of the first polarity and layers comprising electrochemical active material 50, each second terminal tab 24 of the first plurality being one-piece or integral (in German “einstückig”) with one of the second current collectors. The layer(s) of electrochemical active material 50 may be arranged on only one single side or on both sides of each second current collector 48. The electrochemical active material 50 may be a mixture comprising other materials.

Each second terminal tab 24 of the first polarity may be a non-coated portion of the second current collector.

The second electrochemical stack 22 defines a second stack median plane SSMP.

The second electrochemical stack 22 defines a second stack outer face 52 and a second stack inner face 54, the second stack inner face 54 being closer to the first electrochemical stack 16 than the second stack outer face 52. The second stack outer face 52 and the second stack inner face 54 are parallel to one another and the second stack median plane SSMP extends parallel to second stack outer face 52 and the second stack inner face 54 at half the distance of these two faces.

The first electric terminal tab stack 20 overlaps the second electric terminal tab stack 26 and is electrically connected to the tab connection portion 34 of the first terminal 30 via the second electric terminal tab stack 26.

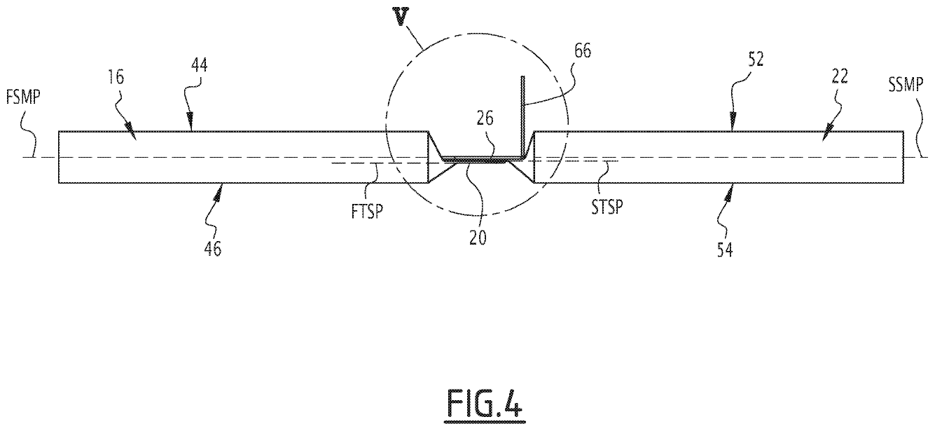

In particular, during manufacturing of the electrochemical assembly, and as depicted in detail on FIG. 4, the first electric terminal tab stack 20 is offset with respect to the first stack median plane FSMP, and the second electric terminal tab stack 26 is offset with respect to the second stack median plane SSMP. More particularly, the first electric terminal tab stack 20 and the second electric terminal tab stack 26 are offset from the respectively associated stack median plane, i.e. the first electric terminal tab stack 20 is offset from the first stack median plane FSMP and the second electric terminal tab stack 26 is offset from the second stack median plane SSMP, at a side either remote from or close to the second electrochemical stack respectively either remote from or close to the first electrochemical stack.

In the assembled state of the electrochemical assembly, this configuration leads to a dissymmetry as explained below.

Each first terminal tab 18 comprises a first free terminal tab portion 56 extending between the associated first current collector 40 and the first electric terminal tab stack 20, each first free terminal tab portion 56 having an effective length EL1.

From each group of two adjacent first terminal tabs 18, the first terminal tab being closer to the first tab stack plane FTSP has a shorter first effective length EL1 of the first free terminal tab portion 56 than the first terminal tab being more distant from the first tab stack plane.

Likewise, each second terminal tab 24 comprises a second free terminal tab portion 58 extending between the associated second current collector 48 and the second electric terminal tab stack 26, each second free terminal tab portion 58 defining an effective length EL2. From each group of two adjacent second terminal tabs 24, the second terminal tab being closer to the second tab stack plane STSP has a shorter second effective length EL2 of the second free terminal tab portion 58 than the second terminal tab being more distant from the second tab stack plane.

The electrochemical assembly defines a first and a second boundary planes 60, 62 coinciding with the first stack outer face 44 respectively the second stack outer face 52. Each and all of the first terminal tabs 18 and each and all of the second terminal tabs 24 are entirely arranged within a space extending between these boundary planes 60, 62. In other words, all of the first terminal tabs 18 and each and all of the second terminal tabs 24 of the electrochemical assembly, or the electrochemical cell, do not protrude in a space outside the projection of the first and second stack outer faces 44 and 52.

The electrochemical assembly comprises a common tab connecting element 66. The common tab connecting element 66 is interposed between the second electric terminal tab stack 26 of the first polarity and the tab connection portion 34 of the first terminal. The common tab connecting element 66 electrically connects the second terminal tab stack 26 to the tab connection portion 34 of the first terminal and electrically links the first terminal tab stack 24 and the second terminal tab stack 26 to the terminal portion of the first terminal.

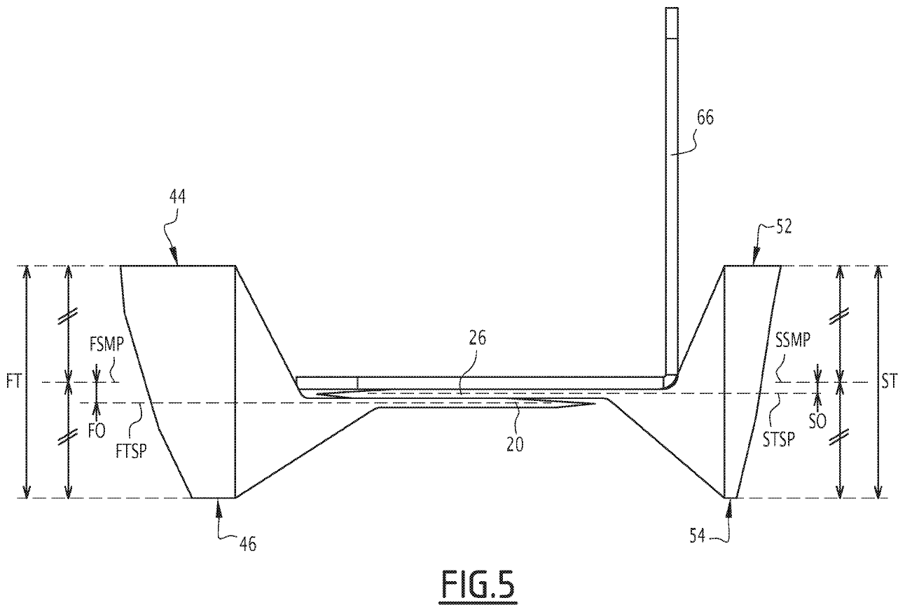

In the present embodiment, the common tab connecting element 66 is a metal strip or strap, one portion of which is fixed to the second terminal tab and one portion of which is fixed to the tab connection portion. These two portions of the metal strip are in the assembled state of the electrochemical cell 2 folded one onto another. During manufacturing, in particular during the fixing step of the first terminal tab stack 20, the second terminal tab stack 26 and the common tab connecting element 66 one to another, the two portions of the common tab connecting element 66 are arranged according to a L-shape (see FIGS. 4 and 5).

Further general features of the electrochemical assembly include:

The first electric terminal tab stack 20 and the second electric terminal tab stack 26 are parallel one to another and extend substantially according to the cover plane B-B perpendicular to the median plane A-A and parallel to the cover plane B-B.

The first electric terminal tab stack 20 and the second electric terminal tab stack 26 are directed in opposite directions and one towards another.

The first electric terminal tab stack 20 is directed towards the second electrochemical stack 22 of electrochemical elements and the second electric terminal tab stack 26 is directed towards the first electrochemical stack 16.

On FIG. 4 is depicted a sub-portion of the electrochemical assembly during manufacturing.

The sub-portion comprises the first electrochemical stack 16, the second electrochemical stack 22 and the common tab connecting element 66.

In the configuration shown, the first stack median plane FSMP and the second stack median plane SSMP are aligned or co-planar with one another. Likewise, the first stack outer face 44 and the second stack outer face 52 are co-planar with one another.

The first electric terminal tab stack 20 extends along a first tab stack plane FTSP and the second electric terminal tab stack 26 extends along a second tab stack plane STSP. The first tab stack plane FTSP and the second tab stack plane STSP are respectively the median plane of the first electric terminal tab stack 20 and the second electric terminal tab stack 26.

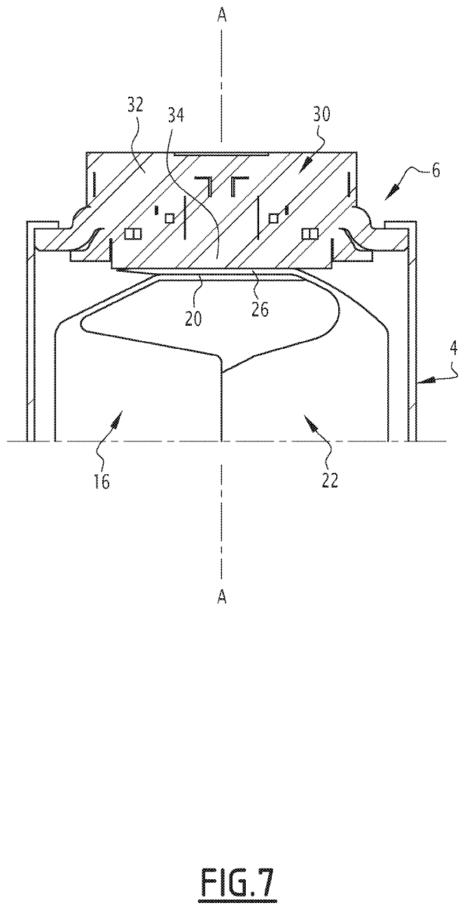

The first tab stack plane FTSP and the second tab stack plane STSP are offset from first stack median plane FSMP and the second stack median plane SSMP, in the direction either towards or remote from the common tab connecting element 66, or in the case of the embodiment of FIG. 7, in the direction towards the terminal (see below).

The first stack outer face 44 and the first stack inner face 46 are at a distance FT which is a thickness of the first electrochemical stack 16. Likewise, the second stack outer face 52 and the second stack inner face 54 are at a distance ST which is a thickness of the second electrochemical stack 22.

The first offset FO of the first tab stack plane FTSP from the first stack median plane FSMP is comprised between 3% and 10% of the thickness FT of the first electrochemical stack 16.

The second offset SO of the second tab stack plane STSP from the second stack median plane SSMP depends on the first offset FO and the thickness of the first and second tab stacks 20 and 26, but may be comprised between 2% to 9% of the thickness ST of the second electrochemical stack 22.

The offsets avoid that too many first terminal tabs 18 or second terminal tabs 24 pull on one side and are excessively compressed on the opposite side. The electrochemical cell is thus reliable.

The first tab stack plane FTSP and the second tab stack plane STSP extend between the first stack outer face 44 and the second stack outer face 52.

FIG. 5 shows the detail IV of FIG. 4 enlarged.

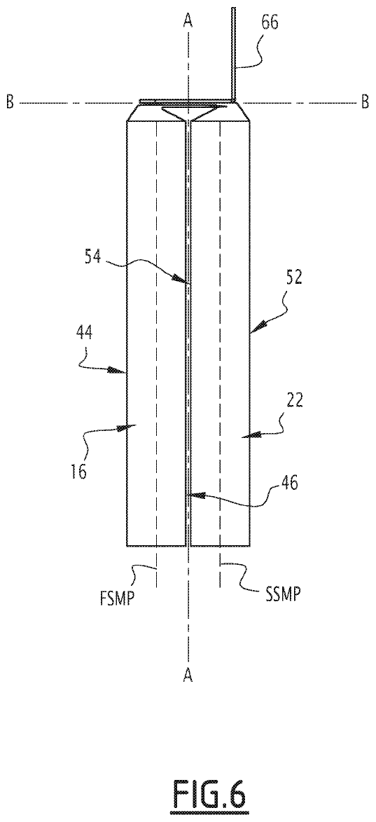

FIG. 6 shows the sub-portion of the electrochemical assembly of FIG. 4, but at a subsequent manufacturing step.

In the configuration of FIG. 6, the first electrochemical stack 16 and the second electrochemical stack 22 have been bent with respect to the common tab connecting element 66 so that the first stack median plane FSMP and the second stack median plane SSMP are parallel one to another and the first tab stack plane FTSP and the second tab stack plane STSP extend perpendicular to the first stack median plane FSMP and the second stack median plane SSMP.

The manufacturing of the electrochemical assembly 8, respectively the electrochemical cell, comprises the following steps:

At first the first electrochemical stack 16, the second electrochemical stack 22, and the first terminal 30 of a first polarity is provided.

Then the first electrochemical stack 16 and the second electrochemical stack 22 are arranged so that the first and second stack median planes FSMP and SSMP are substantially coplanar and the first electric terminal tab stack overlaps the second electric terminal tab stack. The second electric terminal tab stack 26 is arranged between the first electric terminal tab stack 20 and the common tab connecting element 66. The sub-portion takes the configuration shown in FIG. 4.

Subsequently, the first electric terminal tab stack 20 is welded to the second electric terminal tab stack 26, and the second electric terminal tab stack 26 is welded to the common tab connecting element 66 in one single welding operation. The welding operation is for example laser welding or ultrasonic welding.

During the welding operation, the configuration of FIG. 4 is maintained.

After the welding operation, the first electrochemical stack 16 and the second electrochemical stack 22 are folded with respect to the first electric terminal tab stack 20, the second electric terminal tab stack 26 and the common tab connecting element 66, so that the first and second stack median planes are substantially parallel and spaced one from another.

The sub-portion takes the configuration of FIG. 6.

Subsequently, the common tab connecting element 66 is welded to the first terminal 30.

The above operation is repeated for the second polarity.

Thus, the electrochemical assembly is obtained. Then the electrochemical assembly 8 is inserted in the casing and the casing cover is sealed to the casing 4.

On FIG. 7 is shown a variant of the electrochemical assembly disclosed above. The variant differs from the previously disclosed embodiment only by the following. Similar features have the same reference numbers.

The electrochemical assembly comprises no common tab connecting element 66. Thus, the second terminal tab is directly connected to the tab connection portion 34 of the first terminal.

During manufacturing, during the above welding step, the second electric terminal tab stack 26 is welded directly to the tab connection portion 34 of the terminal.

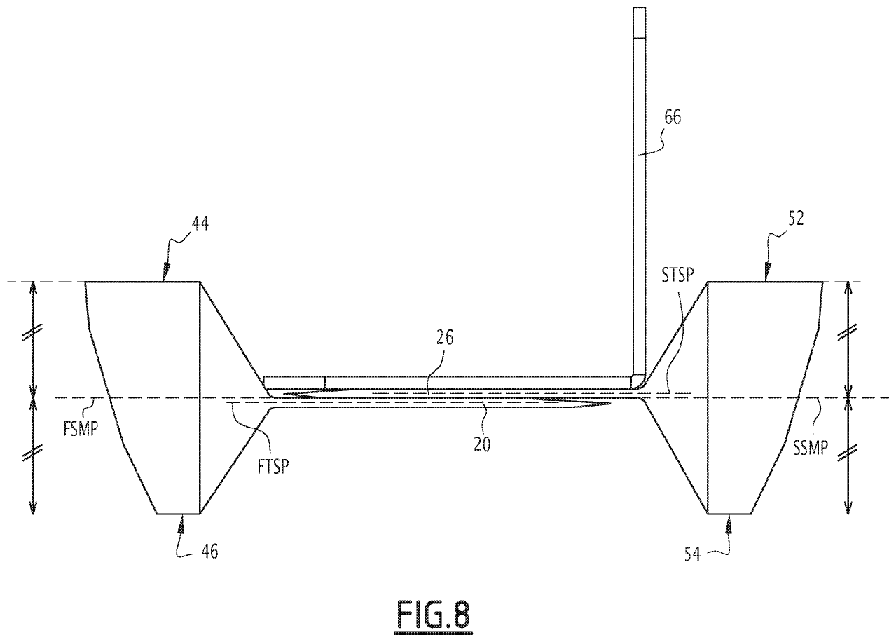

FIG. 8 shows is a view corresponding to the view of FIG. 5 of another variant of an electrochemical cell of FIGS. 1 to 6. The variant differs from the previously disclosed embodiment only by the following. Similar features have the same reference numbers.

During manufacturing of the electrochemical assembly, and as depicted in detail on FIG. 8, the first electric terminal tab stack 20 is essentially not offset with respect to the first stack median plane FSMP, and the second electric terminal tab stack 26 is essentially not offset with respect to the second stack median plane SSMP.

In other words, the first electric terminal tab stack 20 is essentially aligned or co-planar with the first stack median plane FSMP and the second electric terminal tab stack 26 is essentially aligned or co-planar with the second stack median plane SSMP. The first tab stack plane FTSP and the second tab stack plane STSP are thus essentially aligned with one another.

The term “essentially aligned” or “essentially not offset” means that the distance of the first or second electric terminal tab stack or the first or second tab stack plane to the respective first or second stack median plane is not greater than the distance due to the thickness of the electric terminal tab stacks.

The first offset FO and the second offset SO are therefore as small as technically permitted by the thickness of the first and second tab stacks 20 and 26.

The alignment permits an easy manufacturing.

In a non-shown variant, the features of the variant of FIGS. 7 and 8 may be combined. Thus, the electrochemical cell has no connection element 66 and the first electric terminal tab stack 20 is essentially not offset with respect to the first stack median plane FSMP, and the second electric terminal tab stack 26 is essentially not offset with respect to the second stack median plane SSMP.

The electrochemical cell according to the invention as disclosed provides among others the following advantages:

The terminal tab stacks overlapping each other allows obtaining relatively short free tab portions and thus reducing the risk of short-circuits and keeping a minimum stress release to avoid foils cracking during the assembly of the electrochemical cell (closing of the casing)

The amount of material, such as current collector foils, necessary for the manufacture of the cell is also relatively small.

The welding of the tab stacks and possibly the connector in one single step leads to a short cycle time during manufacturing.

1. An electrochemical assembly, comprising
a first electrochemical stack, the first electrochemical stack comprising first stack electrodes of a first polarity and first stack electrodes of a second polarity, the first stack electrodes of the first polarity comprising a plurality of first terminal tabs of the first polarity, the first terminal tabs of the first polarity forming a first electric terminal tab stack,
a second electrochemical stack, the second electrochemical stack comprising second stack electrodes of the first polarity and second stack electrodes of the second polarity, the second stack electrodes of the first polarity comprising a plurality of second terminal tabs of the first polarity, the second terminal tabs of the first polarity forming a second electric terminal tab stack,
a first terminal comprising a terminal portion and a tab connection portion, wherein
the first electric terminal tab stack overlaps the second electric terminal tab stack and is electrically connected to the tab connection portion of the first terminal via the second electric terminal tab stack.

2. The electrochemical assembly according to claim 1, wherein
each of the first stack electrodes of the first polarity comprises a first current collector and an electrochemical active material, each first terminal tab of the first polarity being one-piece or integral with one of the first current collectors, wherein
the first electrochemical stack defines a first stack median plane, and
each of the second stack electrodes of the first polarity comprises a second current collector and an electrochemical active material, each second terminal tab of the first polarity being one-piece or integral with one of the second current collectors, wherein
the second electrochemical stack defines a second stack median plane.

3. The electrochemical assembly according to claim 2, wherein
the first electric terminal tab stack is offset with respect to the first stack median plane,
the second electric terminal tab stack is offset with respect to the second stack median plane.

4. The electrochemical assembly according to claim 2, wherein
the first electric terminal tab stack is essentially aligned with the first stack median plane and the second electric terminal tab stack is essentially aligned with the second stack median plane.

5. The electrochemical assembly according to claim 2, wherein
the first electrochemical stack defines a first stack outer face, and a first stack inner face, and wherein
each first terminal tab of the first polarity comprises a first free terminal tab portion extending between the associated first current collector and the first electric terminal tab stack, each first free terminal tab portion defining a first effective length, and, wherein
from each group of two adjacent first terminal tabs, the first terminal tab being closer to the first tab stack plane has a shorter first effective length of the first free terminal tab portion than the first terminal tab being more distant from the first tab stack plane.

6. The electrochemical assembly according to claim 5, wherein
the second electrochemical stack defines a second stack outer face and a second stack inner face, wherein
each second terminal tab of the first polarity comprises a second free terminal tab portion extending between the associated second current collector and the second electric terminal tab stack, each free terminal tab portion defining a second effective length, and wherein
from each group of two adjacent second terminal tabs, the second terminal tab being closer to the second tab stack plane has a shorter second effective length of the second free terminal tab portion than the second terminal tab being more distant from the second tab stack plane.

7. The electrochemical assembly according to claim 5, wherein
all the first terminal tabs and all the second terminal tabs are entirely arranged within a space extending between two boundary planes coinciding with the first stack outer face respectively with the second stack outer face.

8. The electrochemical assembly according to claim 1, wherein the electrochemical assembly comprises a common tab connecting element, wherein
the common tab connecting element is interposed between the second electric terminal tab stack of the first polarity and the tab connection portion of the first terminal and, wherein
the common tab connecting element electrically connects the second terminal tab stack of the first polarity to the tab connection portion of the first terminal and electrically links the first terminal tab stack and the second terminal tab stack to the terminal portion of the first terminal.

9. The electrochemical assembly according to claim 1, wherein the electrochemical assembly comprises no common tab connecting element and the second terminal tab stack is directly connected to the tab connection portion of the first terminal.

10. The electrochemical cell, comprising a casing, a casing cover and an electrochemical assembly, wherein the electrochemical assembly is an electrochemical assembly according to claim 1, and wherein the first electrochemical stack and the second electrochemical stack are arranged inside the casing.

11. The battery, comprising a plurality of electrochemical cells according to claim 10.

12. The method of manufacturing an electrochemical assembly according to claim 1, or an electrochemical cell according to claim 10, comprising the steps of:
providing:
the first electrochemical stack,
the second electrochemical stack,
the first terminal, the first terminal being of a first polarity,
the first electrochemical stack defining a first stack median plane, and
the second electrochemical stack defining a second stack median plane,
arranging the first electrochemical stack and the second electrochemical stack so that the first and second stack median planes are substantially coplanar and the first electric terminal tab stack overlaps the second electric terminal tab stack,
welding the first electric terminal tab stack to the second electric terminal tab stack, and
folding the first electrochemical stack and the second electrochemical stack so that the first and second stack median planes are substantially parallel and spaced one from another.

13. The method of manufacturing according to claim 12,
wherein during the welding step at least one step of simultaneously welding:
the second electric terminal tab stack to the common tab connecting element; and
the second electric terminal tab stack directly to the tab connection portion.

14. The electrochemical assembly according to claim 3, wherein the first electric terminal tab stack extends along a first tab stack plane and the second electric terminal tab stack extends along a second tab stack plane.

15. The electrochemical assembly according to claim 14, wherein the first electric terminal tab stack and second electric terminal tab stack, and the first tab stack plane and the second tab stack plane, are offset from the respective stack median plane at a side either remote from or close to the second electrochemical stack respectively either remote from or close to the first electrochemical stack.

16. The electrochemical assembly according to claim 3, wherein the first electric terminal tab stack and second electric terminal tab stack, are offset from the respective stack median plane at a side either remote from or close to the second electrochemical stack respectively either remote from or close to the first electrochemical stack.
